(19) United States
(12) Patent Application Publication
(10) Pub. No.: US 2026/0100905 A1
(43) Pub. Date: Apr. 9, 2026

(54) DATA STORAGE NODE EMPLOYING DESTINATION-MODE MACVLAN DRIVER FOR NETWORK PORT SHARING

(71) Applicant: Dell Products L.P., Round Rock, TX (US)

(72) Inventors: Ishay Zekri, Kfar Yona (IL); Marina Shem Tov, Hod Hasharon (IL)

(21) Appl. No.: 18/907,868

(22) Filed: Oct. 7, 2024

(51) Int. Cl. H04L 45/74; H04L 12/46; H04L 45/00

(52) U.S. Cl. CPC H04L 45/74; H04L 12/4675; H04L 45/46

(57) ABSTRACT

A storage processing node of a data storage appliance in a storage cluster has a network port connected to a network for host access and appliance inter-communication. A storage network component of the node is coupled to the network port using a first MACVLAN driver having a first MAC address, and a cluster network component node is coupled to the network port using a second MACVLAN driver, a bond component, and a third MACVLAN driver, the second MACVLAN driver having a second MAC address. The third MACVLAN driver is operated in a Destination mode to (1) maintain a list of MAC addresses, including the second MAC address, for network traffic forwarding, and (2) based on the inclusion of the second MAC address in the list, forward network traffic containing the second MAC address to the bond component for forwarding to the second MACVLAN driver and the cluster network component.

### BACKGROUND

The invention is related to the field of data storage processing.

### SUMMARY

A method is disclosed of operating a data storage node of a data storage appliance in a multi-appliance data storage cluster, where the storage node has a physical network port connected to a physical network via which the appliances of the data storage cluster are accessed by host computers as data storage clients, and via which the appliances communicate for cluster management purposes.

A storage network component of the storage node is functionally coupled to the physical network port using a first MACVLAN driver, the first MACVLAN driver having a link-layer interface to the storage network component using a first MAC address. The first MACVLAN driver is operated to receive, from the physical network port, first network traffic containing the first MAC address as destination address and to deliver the first network traffic to the storage network component.

A cluster network component of the storage node is functionally coupled to the physical network port using a second MACVLAN driver, a bond component, and a third MACVLAN driver, wherein the second MACVLAN driver has a link-layer interface to the cluster network component using a second MAC address, and the bond component serves as a base device for the second MACVLAN driver and forwards second network traffic received from the physical network port thereto. The third MACVLAN driver is operated in a Destination mode to (1) maintain a list of MAC addresses for which the second network traffic is to be forwarded, the list including the second MAC address, and (2) based on the inclusion of the second MAC address in the list, forward the second network traffic containing the second MAC address as destination address to the bond component for forwarding to the second MACVLAN driver and delivery to the cluster network component.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of a computing system including a cluster of data storage appliances;

FIG. 2 is a functional block diagram of a storage processing node, having an arrangement including use of a MACVLAN device in Destination mode for selective packet forwarding;

FIG. 3 is a simplified flow diagram of a method of operating a data storage node;

FIG. 4 is a depiction of a generalization of the arrangement of FIG. 2, which may used in data storage systems or other networked application environments.

### DETAILED DESCRIPTION

### Overview

In computing systems including data storage systems, some applications may be designed or configured in a manner that assumes that network components of the application are directly connected to an underlying physical network. In some cases, these can be existing, or “legacy” applications being deployed in an environment different from the environment of original deployment, and lacking such direction connection, such as when the connection is shared with other networking components. In the field of data storage systems, storage system networks such as iSCSI, NVMe/TCP, NAS, and replication may expect to be directly connected to the physical network.

For such systems, network drivers known as “MACVLAN” drivers may be used to assign respective link-layer (MAC) addresses to each application's virtual network interface, making it appear to be a physical network interface directly connected to the physical network. Typically, it is necessary to designate a physical interface on an operating system and/or container (e.g., Docker) host to use for each MACVLAN. A MACVLAN driver can be used in one of a set of modes of operation including Bridge mode and Passthru mode, and it can provide the ability to integrate Docker and Docker like networking in a simple and lightweight fashion into an underlying network. In operation, a MACVLAN driver filters packets in a particular way, e.g., broadcast traffic or packets having a destination MAC similar to the MACVLAN MAC address, for processing.

In complex systems, including data storage systems or systems having nested containers (“Docker in Docker”), it may be necessary to forward packets between physical to virtual interfaces (not a MACVLAN interface), where the packets'destination MAC does not equal to the virtual interface, but to the MAC of another MACVLAN configured on top of the virtual interface. An example such configuration is shown below. Such a configuration per se could be supported using a MACVLAN in Passthru mode, which allows forwarding all the packets received from the physical interface. However, MACVLAN in Passthru mode does not allow other MACVLAN devices (in any other mode) to be created on top of the same physical interface, which can be required in some systems. In one example, a data storage system has multiple storage networks configured together with an internal cluster management network connected to the same physical interface. Existing MACVLAN modes including Passthru mode may not adequately support such arrangements.

In a disclosed approach, a new MACVLAN operating mode, called “Destination mode,” is used. This new MACVLAN mode is an enhancement that can provide for forwarding packets between physical to virtual interface while still allowing the creation and use of additional MACVLAN devices in different modes on a shared physical network connection/interface. In a disclosed example, a data storage system with two storage networks (iSCSI and NVMe/TCP) are mapped to the same physical port, and an internal cluster management network is also created on top of a virtual interface called a “clustering bond.” In a data storage cluster environment having multiple interconnected appliances, it is desired to connect the internal cluster management network to an external switch, to provide connectivity between the different appliances in the cluster. Using a MACVLAN in destination mode can provide a path between the system bond (at the physical interface) and the clustering bond, so that all network components (including the iSCSI and NVMe/TCP components) can be used with their existing link-layer connectivity.

As described below, a “Destination mode” MACVLAN filters received packets by use of a list of allowed destination MAC addresses. It also preferably supported the forwarding of broadcast/multicast patents, for MACVLAN MAC addresses to be discovered by address resolution protocol (ARP) for example. In a data storage system, the following two use cases can be supported:
1. Enables the creation of multiple untagged storage networks adjacent to internal cluster management network, whose traffic untagged is also untagged.
2. Enables the creation of VLAN tagged storage networks adjacent to internal cluster management network, whose traffic is tagged with the same VLAN ID as the storage networks.

### Embodiments

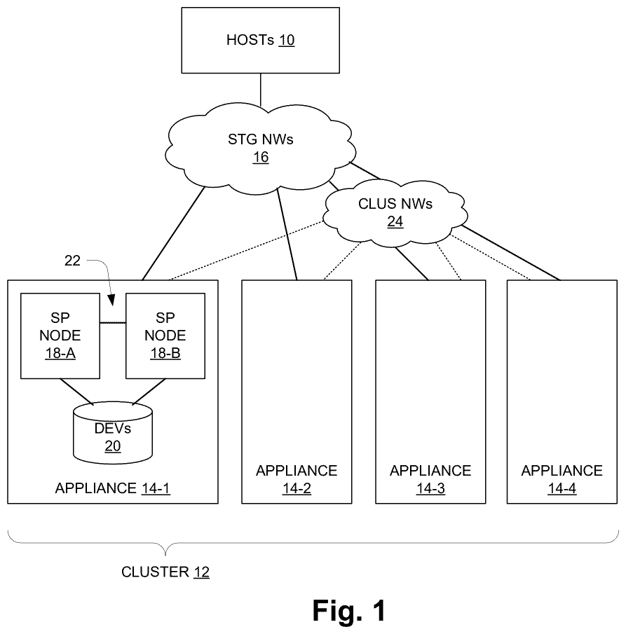

FIG. 1 shows a computing system having a plurality of host computers or “hosts” 10 coupled to a cluster 12 of data storage appliances 14 via one or more storage networks (STG NWs) 16. In the illustrated example, the cluster 12 includes four data storage appliances 14-1 through 14-4. At a high level, each appliance 14 includes a pair of storage processing (SP) nodes 18 (18-A and 18-B as shown) and physical storage devices (DEVs) 20 (such as disk drives, solid state storage devices, etc.). The SP nodes 18A, 18B of each appliance 14 are both connected to the storage devices 20 of the appliance and are also connected together via an inter-node connection 22. The appliances 14 of the cluster 12 are also interconnected by one or more cluster networks (CLUS NWs) 24 for specialized cluster-related communications involving cluster services (e.g., cluster management communications, data migration communications, namespace communications, etc.).

The hosts 10 are constructed and arranged to perform useful work. For example, one or more of the hosts 10 may operate as a file server, a web server, an email server, an enterprise server, a database server, a transaction server, combinations thereof, etc. which provides input/output (IO) requests to the cluster 12. In this context, the hosts 10 may provide a variety of different IO requests (e.g., block and/or file based write commands, block and/or file based read commands, combinations thereof, etc.) that direct the storage and retrieval of data to/from storage (e.g., primary storage or main memory, secondary storage, tiered storage, combinations thereof, etc.).

The appliances 14 of the cluster 12 operate in a federated manner, and the cluster 12 overall provides fault tolerance at a variety of levels to maintain high availability (HA) in the event of a failure. This redundancy includes, for example, the use of redundant storage appliances 14, redundant SP nodes 18 within the storage appliances 14, redundant physical network ports (further described below), etc.

The SP nodes 18 are constructed and arranged to respond to the IO requests received from the hosts 10 by writing data into the set of storage devices 20 and/or reading the data from the storage devices 20 and returning it to requesting hosts 10. Along these lines, the SP nodes 18 operate as storage processing modules, engines, data movers, director boards, blades, etc. From a hardware perspective, each SP node 18 is a computerized device having processing circuitry, memory, and interface circuitry, interconnected by local interconnect such as one or more data buses. The interface circuitry provides external interfaces (e.g., physical network ports) to the networks 16, 24 as well as internal interfaces to the devices 20 and to the co-resident SP node 18. The processing circuitry executes computer program instructions of one or more data storage applications, stored in the memory, to realize various storage-related functionality, using the local storage devices 20 to provide underlying physical storage for logical/virtual presentations of data objects to the hosts 10 as generally known.

Although FIG. 1 depicts the storage networks 16 and cluster networks 24 as distinct, this is primarily a logical/functional view and not necessarily a physical one. In fact, in embodiments these networks can share at least some parts of underlying physical network infrastructure, including for example physical network ports and directly connected physical network switches, as described more below.

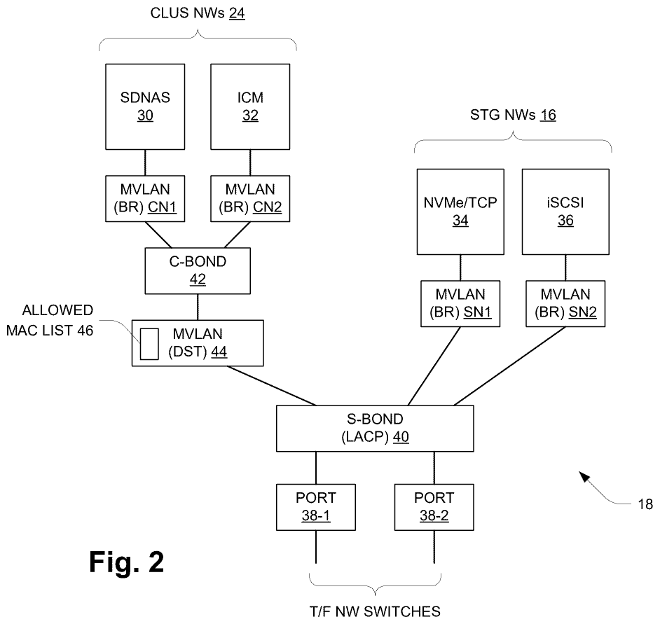

FIG. 2 shows certain functional arrangement of an SP node 18, in which most of the illustrated functional components are realized by execution of corresponding software components of the data storage applications as mentioned above. The node 18 executes components of two distinct cluster networks 24, namely a software-defined network-attached storage (SDNAS) component 30 and an internal cluster management (ICM) component 32. It also executes components of two distinct storage networks 16, namely a Nonvolatile Memory Express over Transmission Control Protocol (NVMe/TCP) component 34 and an internet Small-Computer System Interface (iSCSI) component 36. Each of the components 30-36 is functionally coupled to a pair of physical network ports 38 (38-1 and 38-2) via an arrangement that includes MACVLAN (MVLAN) drivers and components shown as “bonds”. The NVMe/TCP and iSCSI components 34, 36 are coupled directly to a system bond (S-BOND) 40 via respective MVLANs SN1, SN2, which are operated in a “Bridge” (BR) mode as indicated. The system bond 40 is operated in a link-aggregation mode indicated by (LACP). The SDNAS and ICM components 30, 32 are also coupled to the system bond 40, via respective MVLANs CN1, CN2 also in Bridge mode as well as additional components including a cluster bond (C-BOND) 42 and an additional MVLAN 44 operated in a special “Destination” (DST) mode, which is described below. The ports 38 are connected to one or more network switches (not shown) that form part of the physical network infrastructure for networks 16 and 24 (FIG. 1).

In one embodiment, a container-based execution environment is used in which the various distinct components reside and operate in respective sub-environments referred to as “containers.” One example container environment is the so-called “Docker” Linux environment. In this realization, each component 30-36 and it respective MVLAN driver CN1-SN2 are located in a respective container or docker.

The bonds 40, 42 are specialized drivers used to realize logical interfaces for various purposes. As noted, the system bond 40 is operated in a link-aggregation (LACP) manner, using the underlying physical ports 38-1, 38-2 in a load-balancing and/or fault tolerant manner (e.g., active/active, or active/standby). The cluster bond 40 serves as a shared logical interface for the two MVLANs CN1, CN2.

Regarding the MVLANs 44, SN1, SN2, CN1 and CN2, these are used to create multiple interfaces with different Layer 2 (link layer) network addresses, i.e., different Ethernet MAC addresses, on top of a single physical interface or bond. The MVLANs CN1, CN2, SN1 and SN2 are operated in “Bridge” mode, in which the MACVLAN endpoints at a shared interface are connected together with a simple bridge. Thus SDNAS 30 and ICM 32 are bridge-connected, as are the NVMe 34 and iSCSI 36.

Bridge mode has the limitation that only packets having a destination MAC similar to the MACVLAN MAC address are processed, which makes Bridge mode unusable in an arrangement like that of FIG. 2 as discussed below. Although existing MACVLAN implementations also support other operating modes, such as Private mode, Passthru mode, etc., these all have corresponding limitations that prevent their use. As an example, if the MVLAN 44 were operated in Passthru mode, this would readily support the forwarding of traffic from the ports 38 to the MVLANs CN1, CN2. However, Passthru mode has the limitation that only one MACVLAN device is allowed in Passthru mode on top of an interface or VLAN. Using a MACVLAN device in Passthru mode on top of a bond interface does not allow creation of untagged storage networks (e.g., NVMe/TCP 34, iSCSI 36) at the same interface.

In the shared-port arrangement of FIG. 2, it is necessary for the network interface to support both the forwarding of packets to the cluster network components 24, as well as the creation/use of other MACVLAN devices on the same physical interface. More specifically, it is desired to support storage systems use cases including (1) mapping untagged storage networks 16 on the same interface as used for the internal cluster management network, and (2) mapping additional storage network(s) with the same VLAN as the internal cluster management networks 16.

To that end, the MVLAN 44 is operated in a special mode referred to as “Destination” (DST) mode. Operating in this mode, the MVLAN 44 maintains a list (allowed list 46) of MAC addresses for upstream MVLAN devices (MVLANs CN1 and CN2 in this example), and forwards received network traffic accordingly. That is, packets having the destination MAC address MAC-CN1 for MVLAN CN1, are forwarded to MVLAN CN1, and similarly packets having the destination MAC address MAC-CN2 for MVLAN CN2 are forwarded to MVLAN CN2. Any received packets having different MAC addresses (not contained in the allowed list 46) will not be forwarded by MVLAN 44. By using Destination mode for MVLAN 44, the limitations of other modes are avoided, so that the desired packet forwarding is supported as well as the sharing of the physical ports 38 with the storage-network MVLANs SN1, SN2 that are directly connected to the same system bond 40 (shared virtual interface) and operated in Bridge mode.

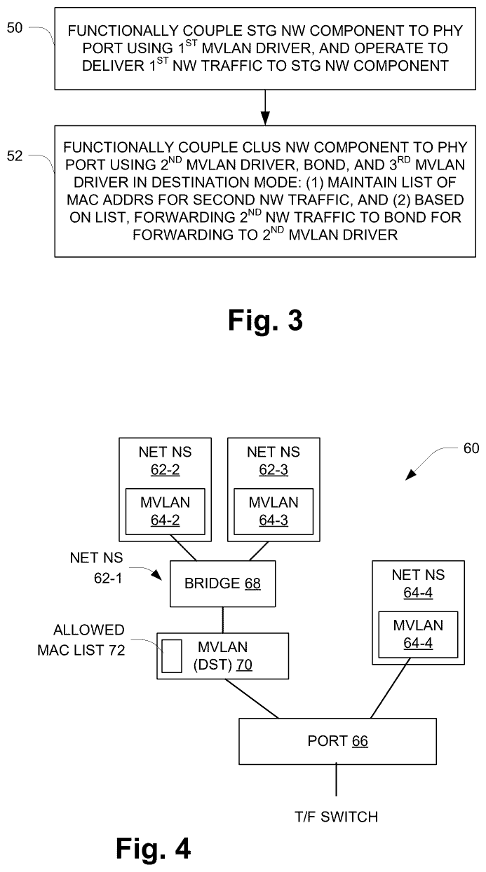

FIG. 3 illustrates pertinent operation of a data storage node (e.g., 18) of a data storage appliance (e.g., 14) in a multi-appliance data storage cluster (e.g., 12), wherein the data storage node has a physical network port (e.g., 38) connected to a physical network via which the appliances of the data storage cluster are accessed by host computers (e.g., 10) as data storage clients, and via which the appliances communicate for cluster management purposes.

At 50, a storage network component (e.g., 34, 36) of the storage node is functionally coupled to the physical network port using a first MACVLAN driver (e.g., SN1, SN2), wherein the first MACVLAN driver has a link-layer interface to the storage network component using a first MAC address. The first MACVLAN driver is operated to receive, from the physical network port, first network traffic containing the first MAC address as destination address and to deliver the first network traffic to the storage network component.

At 52, a cluster network component (e.g., 30, 32) of the storage node is functionally coupled to the physical network port using a second MACVLAN driver (e.g., CN1, CN2), a bond component (e.g., 42), and a third MACVLAN driver (e.g., 44), wherein the second MACVLAN driver has a link-layer interface to the cluster network component using a second MAC address, and the bond component serves as a base device for the second MACVLAN driver and is operative to forward second network traffic received from the physical network port thereto. The third MACVLAN driver is configured and operative in a Destination mode to (1) maintain a list of MAC addresses for which the second network traffic is to be forwarded, the list including the second MAC address, and (2) based on the inclusion of the second MAC address in the list, forwarding the second network traffic containing the second MAC address as destination address to the bond component for forwarding to the second MACVLAN driver and delivery to the cluster network component.

By the above arrangement and operation, in particular the use of Destination-mode MVLAN device(s), the data storage node provides for sharing of physical network ports among a set of application components that have respective link-layer (layer 2) interfaces which assume non-shared physical port access, while also supporting tagged and untagged VLANs for the storage network(s) as noted above.

FIG. 4 shows a generalization 60 of the structure of FIG. 2, as it may be used either in a data storage application as above or in any of a variety of other applications having similar needs, e.g., a computerized device with multiple network components having respective link-layer interfaces to be functionally coupled to a shared physical network port. In this case, the logical networks are divided into respective network namespaces (NET NS) 62, i.e., 62-1, 62-2, 62-3 and 62-4 as shown. MVLAN 64-4 is directly coupled to the physical port 66, while MVLANs 64-2 and 64-3 are indirectly coupled via a bridge component 68 and an MVLAN 70 operated in Destination mode (DST). The MVLAN 70 maintains an allowed MAC list 72 which in this arrangement is populated with the MAC addresses of MVLANs 64-2 and 64-3, and it forwards packets received from the port 66 to the MVLANs 64-2, 64-3 based on the destination address of the packets matching these MAC addresses in the allowed MAC list 72. The MVLANs 64-2 through 64-4 may be operated in any of a variety of other modes, e.g., Private mode, Bridge mode, etc. as briefly explained above.

It will be appreciated that a computerized device employing a generalized structure such as that of FIG. 4 may operate in a manner correspondingly generalized over that of FIG. 3. A first component of the computerized device (e.g., in namespace 62-4) may be functionally coupled to the physical network port using a first MACVLAN driver (e.g., 64-4) that has a link-layer interface to the first component using a first MAC address, and the first MACVLAN driver may be operated to receive, from a physical network port (e.g., 66), first network traffic containing the first MAC address as destination address and to deliver the first network traffic to the first component. Further, a second component of the computerized device (e.g., in namespace 62-2 or 62-3) may be functionally coupled to the physical network port using a second MACVLAN driver, a bond component, and a third MACVLAN driver, wherein the second MACVLAN driver has a link-layer interface to the second component using a second MAC address, and the bond component serves as a base device for the second MACVLAN driver and is operative to forward second network traffic received from the physical network port thereto. The third MACVLAN driver may be operated in a Destination mode to (1) maintain a list of MAC addresses for which second network traffic received from the physical network port is to be forwarded, the list including the second MAC address, and (2) based on the inclusion of the second MAC address in the list, forward the second network traffic containing the second MAC address as destination address to the bond component for forwarding to the second MACVLAN driver and delivery to the second component.

It will also be appreciated that there are many intermediate generalizations that may contain various combinations of specific and generalized structure and functionality taken from FIGS. 2 through 4 and the above summary of generalized operation, and all such intermediate generalizations are deemed to be described herein as far as technically sensible and feasible. For example, one such intermediate generalization is for structure and functionality like those of FIGS. 2 and 3 but in an application other than data storage, having counterparts of the data storage networks 16 and cluster networks 24. Another type of intermediate generalization is the converse, i.e., application in a data storage system but otherwise generalized in one or more ways as reflected in FIG. 4 and the above description of generalized operation, for example.

While various embodiments of the invention have been particularly shown and described, it will be understood by those skilled in the art that various changes in form and details may be made therein without departing from the scope of the invention as defined by the appended claims.

What is claimed is:

1. A method of operating a data storage node of a data storage appliance in a multi-appliance data storage cluster, the storage node having a physical network port connected to a physical network via which the appliances of the data storage cluster are accessed by host computers as data storage clients, and via which the appliances communicate for cluster management purposes, the method comprising:
functionally coupling a storage network component of the storage node to the physical network port using a first MACVLAN driver, the first MACVLAN driver having a link-layer interface to the storage network component using a first MAC address, and operating the first MACVLAN driver to receive, from the physical network port, first network traffic containing the first MAC address as destination address and to deliver the first network traffic to the storage network component; and
functionally coupling a cluster network component of the storage node to the physical network port using a second MACVLAN driver, a bond component, and a third MACVLAN driver, the second MACVLAN driver having a link-layer interface to the cluster network component using a second MAC address, the bond component serving as a base device for the second MACVLAN driver and operative to forward second network traffic received from the physical network port thereto, the third MACVLAN driver being operated in a Destination mode to (1) maintain a list of MAC addresses for which the second network traffic is to be forwarded, the list including the second MAC address, and (2) based on the inclusion of the second MAC address in the list, forward the second network traffic containing the second MAC address as destination address to the bond component for forwarding to the second MACVLAN driver and delivery to the cluster network component.

2. The method of claim 1, wherein the first MACVLAN driver is operated in a Bridge mode providing for packet exchange among MACVLAN drivers connected to a shared physical network port, and wherein operating the third MACVLAN driver in the Destination mode enables the use of the Bridge-mode first MACVLAN while preventing delivery of the first network traffic to the cluster network component.

3. The method of claim 2, wherein the first MACVLAN driver is one of a set of first MACVLAN drivers functionally coupling respective network components to the physical network port, the first MACVLAN drivers being operated in the Bridge mode providing for packet exchange among the first MACVLAN drivers while the third MACVLAN driver operated in the Destination mode prevents the packet exchange from extending to the cluster network component.

4. The method of claim 3, wherein the network components include an internet small-computer system interface (iSCSI) component and a nonvolatile memory express over transmission control protocol (NVMe/TCP) component.

5. The method of claim 1, wherein the second MACVLAN driver is one of a set of second MACVLAN drivers functionally coupling respective cluster network components to the physical network port via the bond component and third MACVLAN driver, and wherein the list of MAC addresses for which the second network traffic is to be forwarded includes respective second MAC addresses of the second MACVLAN drivers, and based on the inclusion of the second MAC addresses in the list, the third MACVLAN driver forwards network traffic containing the second MAC addresses as destination addresses to the bond component for forwarding to the second MACVLAN drivers and delivery to the respective cluster network components.

6. The method of claim 5, wherein the cluster network components include a cluster management component for managing cluster-related operation of the data storage appliances, and a software-defined network attached storage (SDNAS) component for SDNAS-related operation of the cluster.

7. The method of claim 1, wherein the bond component is a cluster bond component, and the MACVLAN drivers are functionally coupled to the physical network as well as an additional physical network port via a system bond.

8. The method of claim 7, wherein the system bond is operated in a link-aggregating manner providing one or more of load balancing and fault tolerance using the physical network ports.

9. A data storage node of a data storage appliance for use in a multi-appliance data storage cluster, the data storage node having a physical network port for connection to a physical network via which the appliances of the data storage cluster are accessed by host computers as data storage clients, and via which the appliances communicate for cluster management purposes, the data storage node being a computerized device configured and arranged to store and execute computer program instructions to:
functionally couple a storage network component of the data storage node to the physical network port using a first MACVLAN driver, the first MACVLAN driver having a link-layer interface to the storage network component using a first MAC address, and operate the first MACVLAN driver to receive, from the physical network port, first network traffic containing the first MAC address as destination address and to deliver the first network traffic to the storage network component; and
functionally couple a cluster network component of the storage node to the physical network port using a second MACVLAN driver, a bond component, and a third MACVLAN driver, the second MACVLAN driver having a link-layer interface to the cluster network component using a second MAC address, and the bond component serving as a base device for the second MACVLAN driver and operative to forward second network traffic received from the physical network port thereto, and operate the third MACVLAN driver in a Destination mode to (1) maintain a list of MAC addresses for which the second network traffic is to be forwarded, the list including the second MAC address, and (2) based on the inclusion of the second MAC address in the list, forward the second network traffic containing the second MAC address as destination address to the bond component for forwarding to the second MACVLAN driver and delivery to the cluster network component.

10. The data storage node of claim 9, wherein the first MACVLAN driver is operable in a Bridge mode generally providing for packet exchange among MACVLAN drivers connected to a shared physical network port, and wherein operating the third MACVLAN driver in the Destination mode enables the use of the bridge-mode first MACVLAN while preventing delivery of the first network traffic to the cluster network component.

11. The data storage node of claim 10, wherein the first MACVLAN driver is one of a set of first MACVLAN drivers functionally coupling respective network components to the physical network port, the first MACVLAN drivers being operable in the Bridge mode providing for packet exchange among the first MACVLAN drivers while the third MACVLAN driver operated in the Destination mode prevents the packet exchange from extending to the cluster network component.

12. The data storage node of claim 11, wherein the network components include an internet small-computer system interconnect (iSCSI) component and a nonvolatile memory express over transmission control protocol (NVMe/TCP) component.

13. The data storage node of claim 9, wherein the second MACVLAN driver is one of a set of second MACVLAN drivers functionally coupling respective cluster network components to the physical network port via the bond component and third MACVLAN driver, and wherein the list of MAC addresses for which the second network traffic is to be forwarded includes respective second MAC addresses of the second MACVLAN drivers, and based on the inclusion of the second MAC addresses in the list, the third MACVAN driver forwards network traffic containing the second MAC addresses as destination addresses to the bond component for forwarding to the second MACVLAN drivers and delivery to the respective cluster network components.

14. The data storage node of claim 13, wherein the cluster network components include a cluster management component for managing cluster-related operation of the data storage appliances, and a software-defined network attached storage (SDNAS) component for SDNAS-related operation of the cluster.

15. The data storage node of claim 9. wherein the bond component is a cluster bond component, and the MACVLAN drivers are functionally coupled to the physical network as well as an additional physical network port via a system bond.

16. The data storage node of claim 15, wherein the system bond is operated in a link-aggregating manner providing one or more of load balancing and fault tolerance using the physical network ports.
